(19) United States
(12) Patent Application Publication
(10) Pub. No.: US 2003/0223048 A1
(43) Pub. Date: Dec. 4, 2003

(54) Projector executing keystone correction

(75) Inventor: Keishi Kimura, Matsumoto-shi (JP)

Correspondence Address: OLIFF & BERRIDGE, PLC, P. O. Box 19928, Alexandria, VA, 22320, US

(73) Assignee: SEIKO EPSON CORPORATION, Tokyo (JP)

(21) Appl. No.: 10/386,534

(22) Filed: Mar. 13, 2003

(30) Foreign Application Priority Data
Mar. 20, 2002 (JP) 2002-079313

(51) Int. Cl. G03B 21/00

(52) U.S. Cl. 353/70

(57) ABSTRACT

This invention achieves an automatic keystone correction which enables even an inexperienced user to easily obtain an image corrected the keystone distortion during a tilted projection. The projector detects varying of its elevation angle by using an elevation detecting module. When the angle stops varying, the projector determines that the elevation adjustment by the user ends, and executes auto keystone correction of the input image according to the elevation angle.

### BACKGROUND OF THE INVENTION

1. Field of Invention

This invention relates to a projector which performs a keystone correction of an image during tilted projection.

2. Description of Related Art

Projectors project images onto screens. In some cases, projectors are set at a low position and project images onto screens that are set at a relatively higher position, which is called “tilted projections”. During the tilted projections, images projected on the screens are distorted to trapezoidal shapes from rectangular shapes due to an elevation angle in the tilted projection. Such a distortion is called “a keystone distortion”.

Related art projectors may include a special button and menu to correct the keystone distortion. A user can adjust the keystone distortion manually with this button and menu. Some related art projectors automatically detect the elevation angle and correct the keystone distortion in response to an instruction from the user.

### SUMMARY OF THE INVENTION

However, for inexperienced users, it is hard to recognize the function of causing the projector to perform the auto keystone correction. Moreover, even if the user knows the function, it often takes the user a long time to understand actual operations for the correction when the type of the projector is unfamiliar for the user.

This invention addresses or solves the above-mentioned problem by providing a technique to make a projector execute an auto keystone correction easily, even when an inexperienced user operates it.

This invention provides a projector that performs a keystone correction of a projected image during a tilted projection. The projector includes a trigger determination module, an elevation detecting module, and a keystone correction module. The trigger determination module determines a predetermined trigger state that is included in normal procedure to project an image except for an instruction to perform a keystone correction. The elevation detecting module detects an elevation angle of the projector. The keystone correction module performs a keystone correction based on the elevation angle in response to the trigger state. For instance, an angle sensor or a G-sensor is applicable for the detection of the elevation angle.

The projector of this invention can automatically execute the keystone correction. Because the trigger state is not a specified operation to instruct the correction but one of states included in the normal procedure, any user can cause the projector to perform the correction without any knowledge about the correction. As a result of this, for example, a presentation with the projector can be started with no loss of time.

Various modifications may be made to the trigger state. As a first exemplary embodiment, the projector further includes an operation determination module that is configured to determine a user operation which is required to projecting an image. The trigger state may include the user operation.

The user operation may include an operation for a power supply. In this case, the keystone correction can be executed in response to the power supply.

When the projector includes an elevation adjustment mechanism, such as stay adjusters, configured to adjust the elevation angle of the projector, the user operation may include an operation of the elevation adjustment mechanism. In this case, the keystone correction can be executed in response to the elevation angle adjustment.

Additionally, the user operation may include various operations, such as focus adjustment, zooming, connecting an image source, and switching to another image source. The image source may include various apparatus, such as DVD players, personal computers, and VCRs, which can be the input source of the image to be projected by the projector. As is mentioned above, the user operation may include various operations required for the user to project images with the projector.

As a second exemplary embodiment, the projector of this invention may further include a light source lamp and an light-on detecting module that is configured to detect a light-on state of the light source lamp. In this case, the trigger state may include the light-on state.

In the second embodiment, the keystone correction can be executed in response to the light-on of the light source lamp. The accuracy of keystone correction may be affected by noises due to the high voltage of the light source lamp. Therefore, it is preferable to execute the correction after the light source lamp lights and a predetermined time passes.

As a third exemplary embodiment, the trigger state may include a variation of the elevation angle. In this embodiment, the keystone correction can be executed when the elevation angle of the projector is changed without any specified operation for the correction. In the third embodiment, the trigger state may include a state that the elevation angle stops varying.

In this case, for example, the state can be detected when a varying rate of the elevation angle decreases below a predetermined value after exceeding over the value once. This detection can reduce a measurement error of the elevation angle due to environmental factors, such as thermal drift of the sensor, thereby stabilizing the correction.

The application of the present invention is not restricted to the projector. There are, however, many other diverse applications, such as a method for correcting keystone distortion of a projected image during a tilted projection of a projector, a computer program that causes a computer to perform the keystone correction, and a computer readable recording medium in which the computer program is recorded, for example. Typical examples of the recording medium include: flexible disks, CD-ROMs, magnet-optic discs, IC cards, ROM cartridges, punched cards, prints with barcodes or other codes printed thereon, internal storage devices (memories such as a RAM and a ROM, for example) and external storage devices of the computer, and a variety of other computer readable media, for example.

### BRIEF DESCRIPTION OF THE DRAWINGS

FIG. 1 is a schematic that shows the general construction of the projector used for the following various exemplary embodiments;

FIG. 2 is a schematic that shows the relationship between the projected image on the screen SC and the image formed on the LC light valve 17;

FIG. 3 is a schematic that shows the principle of detecting the elevation angle of the projector 10;

FIG. 4 is a flowchart of an auto keystone correction process in the projector 10;

FIG. 5 is a graph showing varying the elevation angle of the projector 10; and

FIG. 6 is a flowchart of an auto keystone correction process of a second exemplary embodiment.

### DETAILED DESCRIPTION OF PREFERRED EMBODIMENTS

Exemplary embodiments of the present invention are discussed below in the following sequence:

A. First Embodiment

(A1) General Construction of Projector

(A2) Auto Keystone Correction Process

B. Second Embodiment

C. Modification

A. First Embodiment

(A1) General Construction of Projector

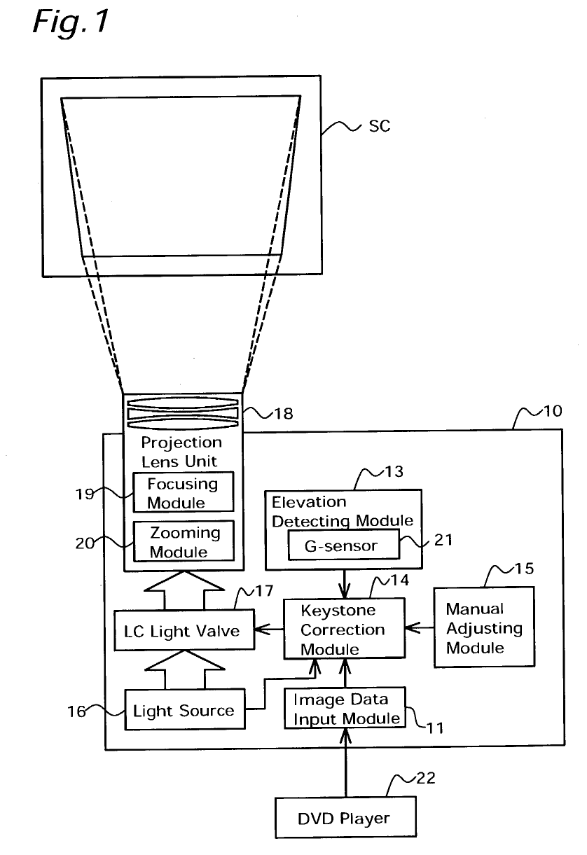

FIG. 1 is a schematic that shows the general construction of the projector used for the following exemplary embodiments. The projector 10 includes an image data input module 11, an elevation detecting module 13, a keystone correction module 14, a manual adjusting module 15, a light source 16, a LC (Liquid Crystal) light valve 17, and a projection lens unit 18.

The image data input module 11 inputs image data from various image output devices. FIG. 1 shows a DVD player 22 as an example of an image output device. The image output devices may include VCRs and personal computers, for example. Moreover, the image data may be delivered via a network.

The elevation detecting module 13 detects the elevation angle of the projector 10 by using G-sensor 21. The principle as to how to detect the elevation angle is described later. The detected elevation angle is transmitted to the keystone correction module 14.

The keystone correction module 14, provided by using a micro-computer with CPU and memories, executes a keystone correction to the image data that is transmitted from the image data input module 11. In this case, the degree of the correction is adjusted according to the elevation angle that is transmitted from the elevation detecting module 13. Moreover, the keystone correction module 14 can perform the correction according to a correction instruction by the user, which is transmitted from the manual adjusting module 15.

The manual adjusting module 15 includes a power supply switch, and a button which allows the user to manually adjust the degree of the keystone correction. The projector 10 is able not only to correct the image by the keystone correction module 14 automatically, but also to perform a manual correction. Accordingly, the user can make a fine adjustment to the image, for instance, after the automatic correction by the keystone correction module 14. The manual adjusting module 15 may be installed in the projector 10, and may also be a remote controller using infrared rays etc.

The light source 16 includes a light source lamp, and a polarizing beam splitter which converts the light from the light source lamp into linear polarized light.

The image that is corrected by the keystone correction module 14 is formed on the LC light valve 17. The image that is transmitted from the image data input module 11 can be directly formed thereon when such a correction is not required.

The LC light valve 17 is illuminated by the light from the light source 16, and the image formed thereon is projected onto the screen SC through the lenses included in the projection lens unit 18.

The projection lens unit 18 includes a zooming module 20 to scale the projected image, and a focusing module 19 to adjust foci according to the distance between the projector and the screen.

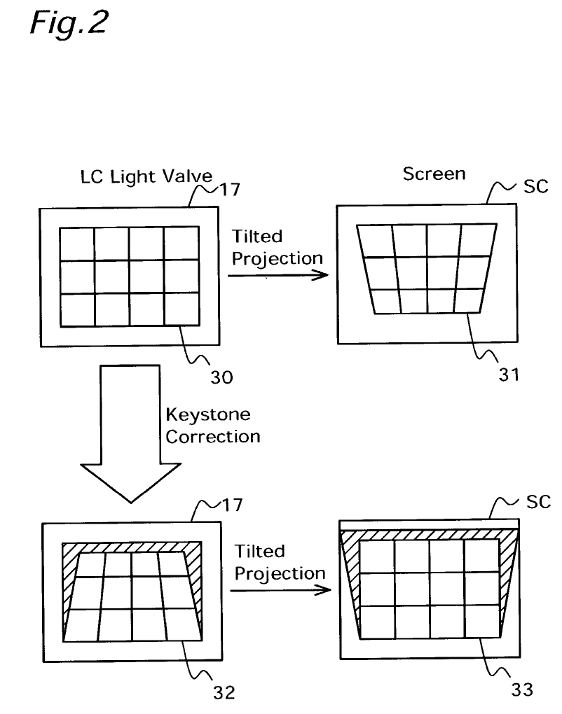

FIG. 2 is a schematic that shows the relationship between the projected image on the screen SC and the image formed on the LC light valve 17. The grid shows the image in FIG. 2. When a tilted projection is performed, the image 30 formed on the LC light valve 17 is projected as the image 31 on the screen SC with the trapezoidal shape. To correct such a trapezoid distortion or a keystone distortion, the keystone correction module 14 corrects the image 30 like image 32 according to the elevation angle of the projector 10, and sets a surrounding blank (hatching part in FIG. 2) to the black area. This correction eliminates the distortion from the projected image 33 on the screen SC during the tilted projection.

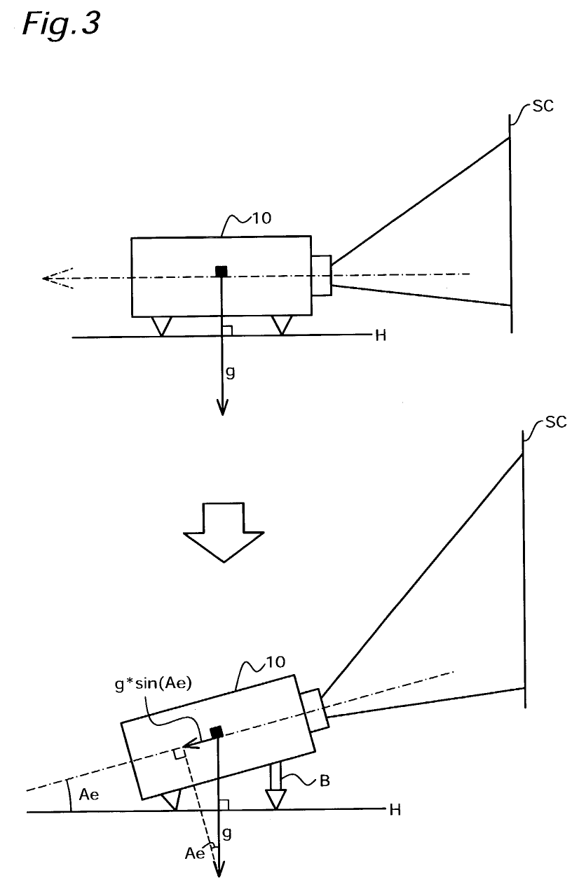

FIG. 3 is a schematic that shows the principle of detecting the elevation angle of the projector 10. FIG. 3 shows right side views of the projector 10, the level floor H on which the projector 10 is placed, and the screen SC. The level floor H is assumed to be horizontal. G-sensor 21 is installed to detect the elevation angle of the projector 10 in this embodiment, as mentioned above. MAS1370P of Mitsubishi Electric Corporation may be used as the G-sensor 21, for example. G-sensor 21 is mounted in the projector 10 and detects the acceleration in the direction of the left side (rear side of the projector 10) on the chain line shown in the upper part of FIG. 3. When the projector 10 is horizontally set on the level floor H and no gravity works along the chain line, the acceleration output from the G-sensor 21 equals zero.

The lower part of FIG. 3 shows the projector 10 set diagonally by adjusting the height of the length of the stay B. Projecting images on the screen SC in such a state is called “a tilted projection”. When the elevation angle is assumed to be Ae, the acceleration element along the chain line equals “g×sin (Ae)” as shown in FIG. 3. G-sensor 21 outputs the voltage corresponding to the acceleration element. In above-mentioned MAS1370P, the voltage of about 17 mV per the elevation angle of 1 degree (acceleration 0.167 m/s²(=9.8 m/s²×0.017)) is output. Therefore, when the elevation angle is 10 degrees, the output of the sensor becomes about 170 mV (=10×17 mV), for instance. The elevation detecting module 13 can detect the elevation angle of the projector 10 based on the voltage output from the G-sensor 21 like this.

Other various detection devices and methods are applicable to detect the elevation angle, and the invention is not restricted to the G-sensor used in this exemplary embodiment. For instance, the elevation angle can be calculated based on the length of the stay, and also detected with an angle sensor which uses a pendulum.

(A2) Auto Keystone Correction Process

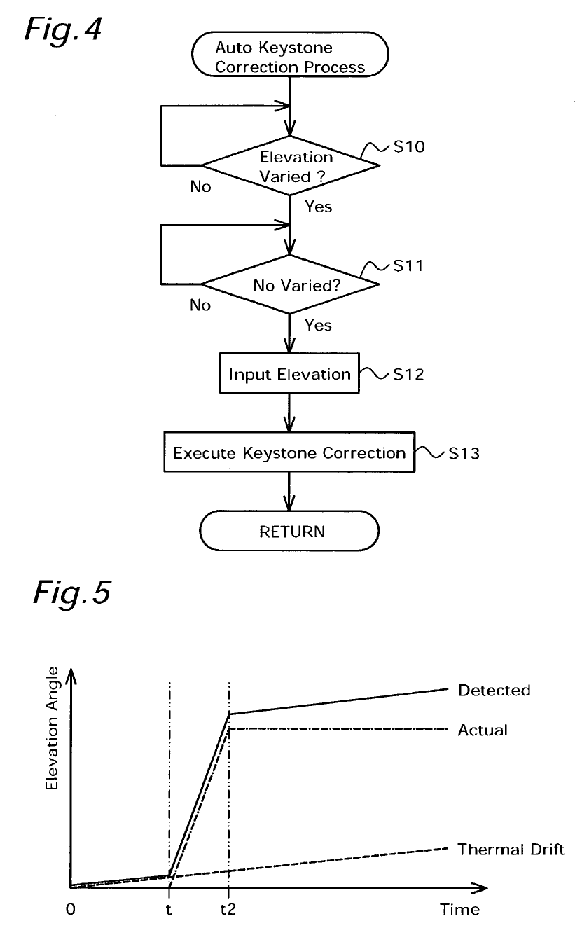

FIG. 4 is a flowchart of an auto keystone correction process in the projector 10. This process is performed by the keystone correction module 14 and using the elevation detecting module 13. First, the keystone correction module 14 detects the variation of the elevation angle by using the elevation detecting module 13 (step S10). The variation suggests that the user starts setting of the projector 10 for a tilted projection.

FIG. 5 is a graph showing varying the elevation angle of the projector 10. The abscissa axis shows the time passage, and the coordinate axis shows the elevation angle. The elevation angle grows after the time “0” when the user turns on the power supply of the projector and the time “t” when the adjustment of the elevation angle of the projector begins. When the adjustment is ended at the time “t2”, the elevation angle achieves a constant value. The chain line, labelled in FIG. 5 as “Actual”, shows this series of variations of the elevation angle.

On the other hand, the dotted line, labelled in FIG. 5 as “Thermal Drift”, shows an increase in detected angle by thermal drift of the G-sensor 21. The temperature rises up to about 75° C. in the projector with the time passage due to the heat of the strong light source lamp. Therefore, the output value of the G-sensor may increase by the influence of the heat like the dotted line of shown in FIG. 5, even when the elevation angle of the projector is actually 0. For instance, the output error rises up to 2 degrees when the temperature is 75° C., in above-mentioned MAS1370P.

This thermal drift causes the detected angle by the elevation detecting module 13 to rise like a solid line labelled in FIG. 5 as “Detected”, which is summation of the thermal drift and the actual angle.

The thermal drift increases gradually for a few minutes, while the adjustment of the elevation angle by the user lasts a few seconds. Accordingly, in this exemplary embodiment, when the time differentiation of the detected angle exceeds a prescribed value, the keystone correction module 14 determines that as the start varying of the elevation angle, so as to clearly distinguish the adjustment by the user from the thermal drift.

Specifically, the start of the variation of the elevation angle can be determined under the following condition: the elevation detecting module 13 detecting the elevation angle using the G-sensor 21 every 0.7 seconds, and the difference between last detected angle and the angles detected eight times in the past being three degrees or more. This condition actualizes an acute detection of the start varying of the elevation angle, even when the thermal drift occurs up to two degrees.

Referring back to FIG. 4, when no variation of the angle is detected at step S10, the keystone correction module 14 keeps observing the angle variation by looping this step. In this way, the keystone correction module 14 can detect whether the tilted projection is applied or not by the user at anytime while the projector 10 works.

Next, the keystone correction module 14 detects whether the detected angle varies less than three degrees compared with the past detected angle (step S11). The process proceeds to the next step, when the variation is less than three, and it can be assumed that the user has stopped installing the projector 10. Otherwise, the keystone correction module 14 keeps observing the end of the installation by looping this step.

The keystone correction module 14 inputs the elevation angle from the elevation detecting module 13 (step S12), and executes the keystone correction of the image according to the elevation angle(step S13) when the completion of the installation is detected, based on the two above-mentioned steps. Thus, the projector 10 can automatically execute the keystone correction of the image due to the tilted projection without a specified operation by the user.

The image may be corrected in real time simultaneously with the elevation angle adjustment by the user, after varying of the angle is detected, while the distortion is corrected after the installation ends in the above-mentioned process. This allows the user to view the corrected image with no delay during the elevation angle adjustment.

B. Second Embodiment

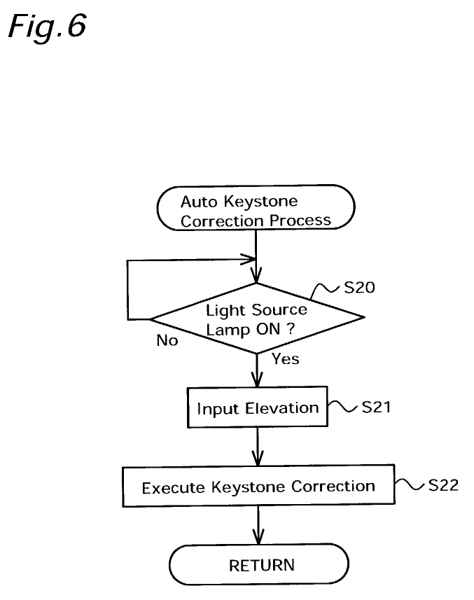

The trigger of auto keystone correction is not restricted to the variation of the elevation angle applied in the first embodiment. FIG. 6 is a flowchart of an auto keystone correction process of the second exemplary embodiment.

First, the keystone correction module 14 detects the light source lamp in the light source 16 lighting (step S20). This detection can be executed by detecting voltage being applied to the power supply line to the light source lamp, for instance. Moreover, a photo-sensor mounted in an arbitrary location that is illuminated by the light source lamp can be used to detect the lighting. In the latter case where a photo-sensor is used the lighting should be detected when the brightness of the light source lamp reaches a prescribed brightness.

The keystone correction module 14 keeps observing the light source lamp by looping this step, in the case where no lighting is detected at step S20. The keystone correction module 14 inputs the elevation angle from the elevation detecting module 13 (step S21), and executes keystone correction based on this angle, when the lighting is detected (step S22). According to this process, keystone correction can be executed in response to a trigger of the lighting of the light source lamp.

It is preferable to input the elevation angle in above-mentioned step S21 after the predetermined time has passed since the lighting was detected at step S20. That is because the noise due to the high voltage, generated by lighting the light source lamp, affects the accuracy of the G-sensor 21.

The trigger is not restricted to the lighting applied in the second exemplary embodiment, and instead various triggers can be used, such as the elevation angle adjustment using the stay, and turning on the power supply, for example. In the latter case, the above-mentioned step S20 that is can be omitted. The operation of the focusing module 19 or the zooming module 20 that is installed in projection lens unit 18 can also be used as the trigger. Keystone distortion is affected by projection distance or projected area, and it is preferable that the amount of the adjustment of the focusing module 19 or the zooming module 20 is reflected in the correction at step S22, thereby executing the correction according to the projection distance and the projected area.

C. Modification

Various modifications can be made to the above exemplary embodiments. Even if the user horizontally sets up projector 10, the elevation detecting module 13 occasionally detects a constant angle. This is an inevitable problem that is caused by the difference of the quality in the manufacturing process of the G-sensor 21 and secular change of sensitivity. Therefore, the elevation detecting module 13 may store the constant angle in advance in the memory in the projector, and determine the angle by subtracting the constant angle from the detected angle. This detection can achieve more accurate correction. The constant angle may be stored in the factory, and also by users after shipping. The manual adjusting module 15 or some specified menus can be used by the user to store the constant angle.

The keystone correction at step S13 or step S22 may be prohibited when the elevation angle that is input at step S21 or step S12 is negative, while the keystone correction executes at every elevation angle in the above-mentioned embodiments. That is because, in that case, the projector is assumed to hang from a ceiling in an upset state by a user who is highly skilled in operating the projector and for whom a manual adjustment button would be more intuitive and easy to understand.

The keystone correction may also be prohibited when right-left reversing projection of the projector is applied, because the user is assumed to be highly skilled.

Moreover, the keystone correction may also be prohibited when the initial detected angle input by the keystone correction module 14 at step S 13 and step S22 is very small (for instance, range of +4 degree and −4 degree). That is because such an angle is possibly a detection error due to secular change of the G-sensor 21 or thermal drift and the projector is possibly set in a horizontal state at the end of the installation.

Additionally, during the distortion correction at step S22 in step S 13, the amount of the correction or the elevation angle that is input by the keystone correction module 14 may be projected onto the screen SC. This could inform the user of a standard of the elevation angle when the user sets up the projector afterwards. Moreover, it is preferable to inform the user by a beep sound or same other alerting method when the automatic distortion correction function works.

The above exemplary embodiments and exemplary modifications are to be considered in all aspects as illustrative and not restrictive. Many modifications, changes, and alterations may be made to the above without departing from the scope or spirit of the present invention. For example, any of the above processing may be performed by hardware, instead of the software.

What is claimed is:

1. A projector performing a keystone correction of a projected image during a tilted projection, the projector comprising:
a trigger determination module configured to determine a predetermined trigger state included in normal procedure to project an image except for an instruction for performing a keystone correction;
an elevation detecting module configured to detect an elevation angle of the projector; and
a keystone correction module configured to perform a keystone correction based on the elevation angle in response to the trigger state.

2. A projector in accordance with claim 1, further comprising:
an operation determination module configured to determine a user operation which is required to projecting an image;
wherein the trigger state includes the user operation.

3. A projector in accordance with claim 2,
wherein the user operation includes an operation for a power supply.

4. A projector in accordance with claim 2, further comprising:
an elevation adjustment mechanism configured to adjust the elevation angle of the projector;
wherein the trigger state includes an operation of the elevation adjustment mechanism.

5. A projector in accordance with claim 1, further comprising:
a light source lamp;
an light-on detecting module configured to detect a light-on state of the light source lamp;
wherein the trigger state includes the light-on state.

6. A projector in accordance with claim 1,
wherein the trigger state includes a variation of the elevation angle.

7. A projector in accordance with claim 6,
wherein the trigger state includes a state that the elevation angle stops varying.

8. A projector in accordance with claim 7,
wherein the keystone correction module determines the stop when a varying rate of the elevation angle decreases below a predetermined value after once exceeding over the value.

9. A method for correcting keystone distortion of a projected image during a tilted projection of a projector, the method comprising steps of:
determining a predetermined trigger state included in normal procedure to project an image except for an instruction for performing a keystone correction;
detecting an elevation angle of the projector; and
performing a keystone correction based on the elevation angle in response to the trigger state.

10. A method in accordance with claim 9, further comprising:
determining a user operation which is required to projecting an image;
wherein the trigger state includes the user operation.

11. A method in accordance with claim 10,
wherein the user operation includes an operation for a power supply.

12. A method in accordance with claim 10, further comprising:
wherein the trigger state includes an operation of an elevation adjustment mechanism, which is equipped with the projector to adjust the elevation angle.

13. A method in accordance with claim 9, further comprising:
detecting a light-on state of a light source lamp of the projector;
wherein the trigger state includes the light-on state.

14. A method in accordance with claim 9,
wherein the trigger state includes a variation of the elevation angle.

15. A method in accordance with claim 14,
wherein the trigger state includes a state that the elevation angle stops varying.

16. A method in accordance with claim 15,
wherein the stop varying is determined when a varying rate of the elevation angle decreases below a predetermined value after once exceeding over the value.
